(19) United States
(12) Patent Application Publication
(10) Pub. No.: US 2017/0257658 A1
(43) Pub. Date: Sep. 7, 2017

(54) METHOD FOR AUTOMATICALLY PUSHING VIDEO BASED ON ANALYSIS OF USER BEHAVIOR AND ELECTRONIC DEVICE

(71) Applicants: Le Holdings (Beijing) Co., Ltd., Beijing (CN); LeCloud Computing Co., Ltd., Beijing (CN)

(72) Inventor: Yong MA, Beijing (CN)

(21) Appl. No.: 15/243,952

(22) Filed: Aug. 22, 2016

Related U.S. Application Data
(63) Continuation of application No. PCT/CN2016/089234, filed on Jul. 7, 2016.

(30) Foreign Application Priority Data
Mar. 2, 2016 (CN) 201610119230.9

(51) Int. Cl. H04N 21/2668; H04N 21/234; H04N 21/2362; H04N 21/81; H04N 21/258; H04N 21/25

(52) U.S. Cl. CPC H04N 21/2668; H04N 21/25891; H04N 21/251; H04N 21/2362; H04N 21/812; H04N 21/23418; H04N 21/44218

(57) ABSTRACT

A method for automatically pushing a video based on user behavior analysis is disclosed. The method includes: at an electronic device, obtaining a watching record of a video file; determining whether there is a video file of which a watching duration is greater than a preset duration threshold according to the watching record; extracting a video information identification (ID) of the video file if there is a video file of which the watching duration is greater than the preset duration threshold; storing the video information ID into a video update table if there is a video file having the same video information ID; and pushing the update information if it is monitored that there is update information of the video file corresponding to the video information ID in the video update table.

### CROSS REFERENCE TO RELATED APPLICATIONS

The present disclosure is a continuation application of PCT International patent application No. PCT/CN2016/089234, filed on Jul. 7, 2016, which claims priority to Chinese Patent Application No. 201610119230.9, filed with the Chinese Patent Office on Mar. 2, 2016, both of which are herein incorporated by reference in their entireties.

### TECHNICAL FIELD

The present disclosure relates to the field of communication technologies, and particularly, to a method for automatically pushing a video based on user behavior analysis and an electronic device.

### BACKGROUND

With the advancement of the computer communication technologies, the Internet technologies and the multimedia technologies, watching video has become more and more popular. Currently, the demand for browsing and watching the video becomes increasingly higher, but in many cases (i.e., during the commuter time, in the outdoor environment and etc.) there is no satisfactory network condition available for satisfying people's needs. Additionally, other reasons such as high network communication fees or instable network signals also prevent the users from browsing and watching videos.

A typical solution is as follows: the user logs into a multimedia platform when the network condition is satisfactory and, chooses and downloads a video depending on his or her need for browsing and watching later.

### SUMMARY

A method for automatically pushing a video based on user behavior analysis is provided in an embodiment of the present disclosure. The method includes: at an electronic device, obtaining a watching record of a video file; determining whether there is a video file of which a watching duration is greater than a preset duration threshold according to the watching record; extracting a video information identification (ID) of the video file if there is a video file of which the watching duration is greater than the preset duration threshold; storing the video information ID into a video update table if there is a video file having the same video information ID; and pushing the update information if it is monitored that there is update information of the video file corresponding to the video information ID in the video update table.

An electronic device is provided in an embodiment of the present disclosure. The electronic device includes at least one processor and a memory. The memory is communicably connected with the at least one processor for storing instructions executable by the at least one processor, wherein execution of the instructions by the at least one processor causes the at least one processor to:

obtain a watching record of a video file;

determine whether there is a video file of which a watching duration is greater than a preset duration threshold according to the watching record;

extract a video information identification (ID) of the video file if there is a video file of which the watching duration is greater than the preset duration threshold;

store the video information ID into a video update table if there is a video file having the same video information ID; and

push the update information if it is monitored that there is update information of the video file corresponding to the video information ID in the video update table.

A non-transitory computer-readable storage medium is provided in an embodiment of the present disclosure. The non-transitory computer-readable storage medium stores executable instructions, wherein when executed by an electronic device, causes the electronic device to:

obtain a watching record of a video file;

determine whether there is a video file of which a watching duration is greater than a preset duration threshold according to the watching record;

extract a video information identification (ID) of the video file if there is a video file of which the watching duration is greater than the preset duration threshold;

store the video information ID into a video update table if there is a video file having the same video information ID; and

push the update information if it is monitored that there is update information of the video file corresponding to the video information ID in the video update table.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart diagram of a method for automatically pushing a video based on user behavior analysis according to an embodiment of the present disclosure;

FIG. 2 is a schematic flowchart diagram of a method for automatically pushing a video based on user behavior analysis according to another embodiment of the present disclosure;

FIG. 3 is a schematic structural diagram of an apparatus for automatically pushing a video based on user behavior analysis according to an embodiment of the present disclosure;

FIG. 4 is a schematic structural diagram of an apparatus for automatically receiving a video based on user behavior analysis according to an embodiment of the present disclosure; and

FIG. 5 is a schematic structural diagram of an electronic device according to an embodiment of the present disclosure.

### DETAILED DESCRIPTION

To make the objective, technical solutions and advantages of the present disclosure clearer, the present disclosure will be further detailed with reference to embodiments thereof and the attached drawings.

In the current state of multimedia platforms, the user logging into a multimedia platform can only check on his own if there is any update for a video file in which he is interested, and if there is an update, manually buffers the update. This leads to very poor user experiences. To solve this problem, the present disclosure is intended to satisfy the user's demand for automatically downloading updates of a video file in which the user is interested. Accordingly, the idea of the present disclosure is to fulfill the function of automatically downloading.

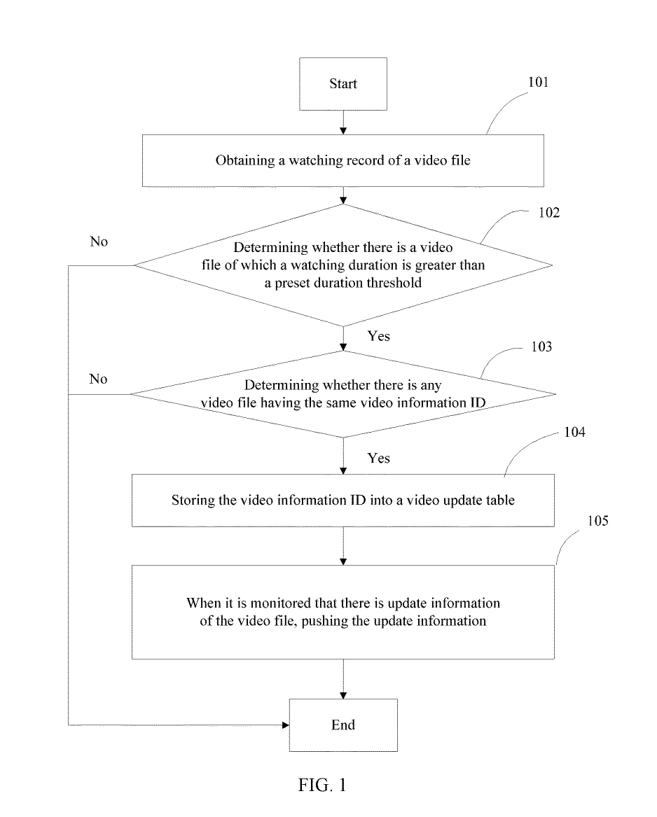

FIG. 1 is a schematic flowchart diagram of a method for automatically pushing a video based on user behavior analysis according to an embodiment of the present disclosure. The method for automatically pushing a video based on user behavior analysis includes the following steps:

Step 101: obtaining a watching record of a video file.

In an embodiment, the user may log into a multimedia playing platform, and because a historical watching record is stored for each user, the watching record of each user can be obtained. Here, the watching record may include such contents as user terminal information, video information identification (ID) and watching duration.

Step 102: determining whether there is a video file of which a watching duration is greater than a preset duration threshold according to the watching record, wherein if there is, then the process proceeds to step 103, and otherwise, the process exits.

In an embodiment, it is determined for each video file in the watching record whether the watching duration is greater than the preset duration threshold. If the determination result is yes, then it can be preliminarily determined that the user is interested in the video file and the process may proceed to the step 103. If the watching duration of none of the users is greater than the preset duration threshold, then the process exits directly.

In another embodiment of the present disclosure, in the process of determining whether there is a video file of which a watching duration is greater than a preset duration threshold, a watching time period of the video file is obtained, and it is determined whether there is an advertisement playing time within the watching time period. If there is, then it is determined whether the watching duration minus the advertisement playing time is greater than the preset duration threshold; and if there is not, it is directly determined whether the watching duration is greater than the preset duration threshold.

Step 103: extracting a video information identification (ID) of the video file and determining whether there is any video file having the same video information ID, and if there is a video file having the same video information ID, then the process proceeds to step 104, and otherwise, the process exits.

Here, the video information ID is information used to distinguish different video files, which may include one or a combination of the name, the version number, the lead role, the publication time or the like of the video file. In the present embodiment, the extracted video information of the video file is at least two pieces of video information of the video file (e.g., the name and the publication time of the video file), and this allows for determining video files having the same video information more precisely. Additionally, the purpose of determining whether there is any video file having the same video information ID is to categorize video files that have been preliminarily determined (step 102), and video files having the same video information may be considered to be of the same category; for example, a TV play has video files of a plurality of episodes, and the video information of the TV play can be obtained by extracting video information of these video files. Then the process proceeds to the step 104.

Step 104: storing the video information ID into a video update table.

In an embodiment of the present disclosure, if there is any video file having the same video information ID, the number of the video files having the same video information ID is calculated, and for all video files, the numbers of video files having a same video information are sorted in the order of the numbers, and the numbers of the video information IDs are stored into the preset video update table in sequence. A larger number of video files having a same video information ID means that users are more interested in the video file. For example, because different episodes of a TV play correspond to a same video information ID, a larger number of video files having the same video information ID generally means that a larger number of episodes are watched and, hence, users are more interested in the TV play.

Step 105: when it is monitored that there is update information of the video file corresponding to the video information ID in the video update table, pushing the update information.

In an embodiment, the video update table stores correspondence relationships between each video information ID and update information therein. When it is monitored at the multimedia playing platform side that there is update information of the video file corresponding to the video information ID in the video update table, the update information may be pushed to the corresponding user terminal according to the user terminal information in the watching record. Thereby, this embodiment achieves the purpose of monitoring video information of the video file in which the user is interested and, meanwhile, automatically pushing the update information to the terminal so that the terminal can download the updated video file according to the update information.

In an embodiment of the present disclosure, the present disclosure further provides a method for automatically receiving a video based on user behavior analysis. Specifically, when the update information pushed by the multimedia platform is received by the terminal, a power level of the terminal may be obtained. Then it is determined whether the power level of the terminal is lower than a preset power level threshold. If the power level of the terminal is not lower than the preset power level threshold, then the numbers of video files having a same video information ID are ordered and downloading is performed according to the ordering result. If the power level is lower than the preset power level threshold, then the update information will not be downloaded. Here, update information corresponding to a greater number of video files having a same video information ID will be ordered more ahead for downloading. Thereby, this embodiment allows for downloading a video files in which users are more interested more preferentially in consideration of the power level of the terminal.

As an embodiment of the present disclosure, a network monitoring process is activated when the update information pushed by the multimedia platform is received by the terminal so that, when it is monitored that the network of the terminal is in a non-mobile data network state, downloading is performed according to the update information. Additionally, in the process of downloading the video file according to the update information, a memory monitoring process is activated so that when it is monitored that a utilization ratio of an available memory of the terminal is higher than a preset utilization ratio, the downloading is paused, and otherwise, the downloading is continued. Accordingly, this embodiment can take the utilization conditions of the memory of the terminal into consideration, that is, pauses the downloading when the utilization ratio is high and continues the downloading when the utilization ratio becomes low.

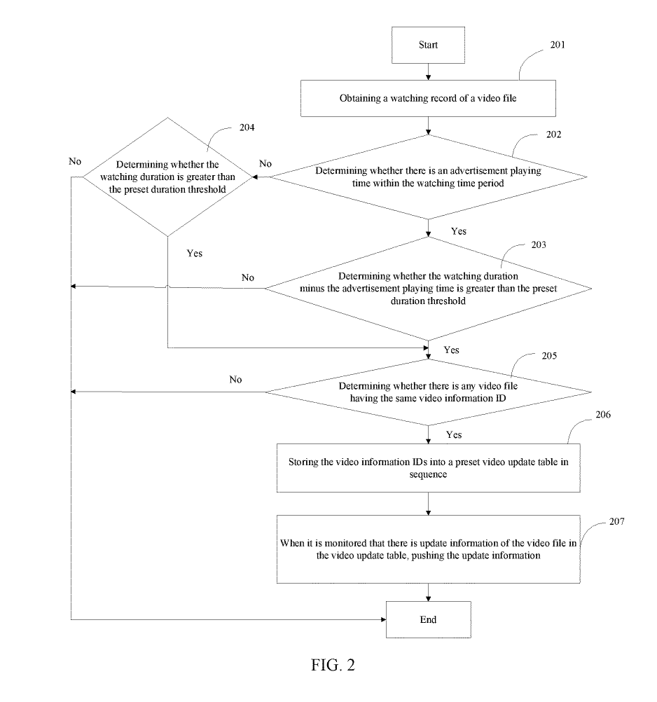

As another embodiment, as shown in FIG. 2, the method for automatically pushing a video based on user behavior analysis may adopt the following steps:

Step 201: obtaining a watching record of a video file.

Step 202: obtaining a watching time period of the video file, and determining whether there is an advertisement playing time within the watching time period, wherein if there is, then the process proceeds to the step 203 and otherwise, to the step 204.

Step 203: determining whether the watching duration minus the advertisement playing time is greater than the preset duration threshold, and if not, the process proceeds to the step 205 and otherwise, the process exits directly.

Step 204: determining whether the watching duration is greater than the preset duration threshold, and if the determination result is yes, then the process proceeds to the step 205 and otherwise, the process exits directly.

Step 205: extracting a video information ID of the video file and determining whether there is any video file having the same video information ID, and if there is a video file having the same video information ID, then the process proceeds to step 206, and otherwise, the process exits directly.

Step 206: calculating the number of video files having the same video information ID, sorting video files in the order of the numbers of video files having the same video information, and storing the number of video information IDs into the video update table in the ordering sequence.

Step 207: pushing the update information to the terminal when it is monitored that there is update information of the video file corresponding to the video information ID in the video update table.

In an embodiment, the terminal receives the update information of the video file, obtains a power level of the terminal, and determines whether the power level of the terminal is lower than a preset power level threshold. If the power level of the terminal is not lower than the preset power level threshold, then the numbers of video files having a same video information ID are sorted according to the update information and the downloading is performed according to the sorting result. Otherwise, if the power level of the terminal is lower than the preset power level threshold, then no processing is made.

In another embodiment of the present disclosure, the terminal having received the update information pushed by the multimedia platform may activate a network monitoring process. Then, when it is monitored that the network of the terminal is in a non-mobile data network state, download is performed according to the update information. Additionally, in the process of downloading the video file according to the update information, a memory monitoring process is activated so that when it is monitored that a utilization ratio of an available memory of the terminal is higher than a preset utilization ratio, the downloading is paused, and otherwise, the downloading is continued.

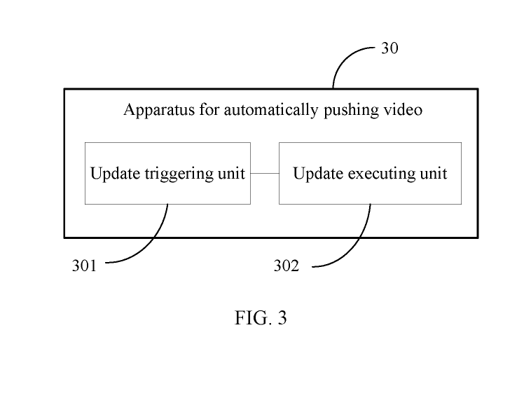

In another aspect, an apparatus for automatically pushing a video based on user behavior analysis is also provided in an embodiment of the present disclosure. As shown in FIG. 3, the apparatus for automatically pushing a video based on user behavior analysis includes an update triggering unit 301 and an update executing unit 302 connected in sequence. The update triggering unit is configured to obtain a watching record of a video file; determine whether there is a video file of which a watching duration is greater than a preset duration threshold according to the watching record; if there is, extract a video information ID of the video file and determine whether there is any video file having the same video information ID; and if there is a video file having the same video information ID, store the video information ID stored into a video update table and, otherwise, make no processing. The update executing unit 302 is configured to, when it is monitored that there is update information of the video file corresponding to the video information ID in the video update table, push the update information. It shall be appreciated that, the video update table stores correspondence relationships between each video information ID and the update information therein.

In another embodiment, the update triggering unit 301 determining whether there is a video file of which a watching duration is greater than a preset duration threshold is specifically implemented by: obtaining a watching time period of the video file; determining whether there is an advertisement playing time within the watching time period; if there is, then determining whether the watching duration minus the advertisement playing time is greater than the preset duration threshold; and if there is not, directly determining whether the watching duration is greater than the preset duration threshold.

As an embodiment of the apparatus, if there is a video file having the same video information ID, the update triggering unit 301 may be further configured to: calculate the number of video files having the same video information ID, sort video files in the order of the numbers of video files having the same video information, and store the number of video information IDs into the video update table in sequence.

It shall be appreciated that, detailed implementations of the apparatus for automatically pushing a video based on a user flag have been detailed in the aforesaid method for automatically pushing a video based on a user flag, so they will not be further described herein again.

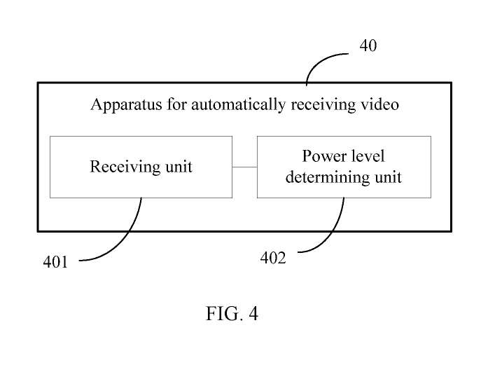

Additionally, as shown in FIG. 4, an embodiment of the present disclosure also provides an apparatus for automatically receiving a video based on user behavior analysis, which includes a receiving unit 401 and a power level determining unit 402. The receiving unit 401 receives the update information. Then the power level determining unit 402 determines whether a power level of the terminal is lower than a preset power level threshold; if the power level of the terminal is not lower than the preset power level threshold, then performs downloading according to the sorting result, and otherwise, make no processing. Further, after receiving the update information, the receiving unit 401 activates a network monitoring process so that, when it is monitored that the network of the terminal is in a non mobile data network state, a current power level of the terminal is obtained.

In another embodiment, after downloading is preformed according to the sorting result, the power level determining unit 402 may activate a memory monitoring process so that when a utilization ratio of an available memory of the terminal is higher than a preset utilization ratio, the downloading is paused, and otherwise, the downloading is continued.

It shall be appreciated that, detailed implementations of the apparatus for automatically receiving a video based on a user flag have been detailed in the aforesaid method of automatically receiving a video based on a user flag, so they will not be further described herein again.

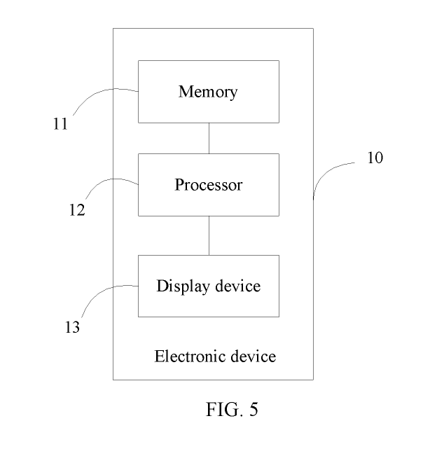

FIG. 5 is a schematic structural diagram of an electronic device 10 provided in an embodiment of the present disclosure. As shown in FIG. 5, the electronic device 10 includes a memory 11, a processor 12, and a display device 13.

The memory 11 is configured to store instructions.

The processor 12 is configured to execute the instructions stored in the memory 11, so as to obtain a watching record of a video file, determine whether there is a video file of which a watching duration is greater than a preset duration threshold according to the watching record, extract a video ID of the video file if there is a video file of which the watching duration is greater than the preset duration threshold, determine whether there is any video file having the same video information ID, and store the video information ID into a video update table if there is a video file having the same video information ID; if there is no a video file having the same video information ID, making no processing; when it is monitored that there is update information of the video file corresponding to the video information ID in the video update table, push the update information.

The display device 13 is configured to display graphic user interface.

The memory 11 of the electronic device 10 may be a non-transitory computer readable storage medium for storing computer executable instructions. For example, when being executed by one or more processors, enable the processor to execute steps of the method in the embodiments described above, e.g., the steps 101 to 106 described in FIG. 1, or the steps 201 to 207 described in FIG. 2, or achieve the function of units 301-302 described in FIG. 3, or achieve the function of units 401-402 described in FIG. 4. The computer executable instructions may also be stored and/or transmitted in any non-transitory computer readable storage medium for use in an instruction execution system, apparatus or device or for use in combination with an instruction execution system, apparatus or device. The instruction execution system, apparatus or device is, for example, a computer-based system, a system including a processor, or some other system that can obtain instructions from the instruction execution system, apparatus or device and execute the instructions. For purpose of this document, the “non-transitory computer readable storage medium” may be any tangible medium that contains or stores computer executable instructions which may be used by or in combination with the instruction execution system, apparatus or device. The non-transitory computer readable storage medium may include but is not limited to magnetic, optical and/or semiconductor storage devices. Examples of these storage devices include magnetic disks, optical disks based on CD, DVD or Blu-ray technologies, and persistent solid-state storages (e.g., flash memories, solid-state drives and etc).

The processor 12 may be a central processing unit (CPU). The processor 12 may also be some other general-purpose processor, digital signal processor (DSP), application specific integrated circuit (ASIC), field programmable gate array (FPGA) or some other programmable logic element, discrete gate or transistor logic element, discrete hardware component and etc. The general-purpose processor may be a microprocessor or may be any common processor.

The processor 12 and the memory 11 is, directly or indirectly, in communication with each other by means of any appropriate means including, but not limiting to power supply buses, control buses, state signal buses and so on, so as to achieve data transmission.

The electronic device 10, provided in the embodiment of the present disclosure, makes analysis on user behaviors according to the video file watching record, so as to obtain video files in which the user is interested, and automatically push the update information, thus greatly optimizing the service efficiency of the multimedia playing platform.

As shall be understood by those skilled in the art, various functional units/modules and various steps may be implemented by electrical hardware, computer software, or the combination of both. In order to clearly illustrate the interchangeability of electrical hardware and computer software, the functional units/modules and steps of the above embodiments are described in a general way. Performing the functional units/modules and steps of the above embodiments by means of electrical hardware, computer software, or the combination of both, depends on the specific applications and design constrain conditions of the technical solutions. Those skilled in the art may apply different solutions for each specific application to achieve the functional units/modules and steps of the above embodiments, however, these different solutions should be deemed to be within the scope of the present disclosure. The computer software may be stored in a computed readable storage medium, and can perform the steps of the method in the above described embodiments when being executed. Wherein, the storage medium may be a magnetic disk, an optical disc, a read-only memory, a random memory or the like.

In summary, the method and the apparatus for automatically pushing a video based on user behavior analysis provided in the embodiments of the present disclosure creatively make analysis on the historical watching behaviors of the user to obtain video files that the user possibly desires to download; and meanwhile, for the video file that the user desires to download, the update content thereof is monitored and automatically downloaded; in this way, update contents are pushed to the user and downloaded directly without the need of user intervention; this has a broad and significant sense for promotion; and finally, the method and the apparatus for automatically pushing a video based on user behavior analysis are compact and easy to control.

As shall be appreciated by those of ordinary skill in the art, the above discussion of any embodiments is only illustrative and is not intended to imply that the scope (including the claims) of the present disclosure is limited to these examples; and within the spirits of the present disclosure, technical features of the above embodiments or different embodiments may be combined with each other, the steps may be achieved in any sequence, and there are many other variations in different aspects of the present disclosure described above, although they are not detailed for purpose of simplicity.

Additionally, for simplicity of the description and discussion and to prevent that the present disclosure is difficult to understand, publicly known power supply connections/ground connections with integrated circuits (ICs) and other parts may be or may not be shown in the attached drawings. Furthermore, the apparatus may be shown in the form of a block diagram to prevent that the present disclosure is difficult to understand and out of consideration of the following facts: details of implementations of the blocks are highly dependent on the platform on which the present disclosure is to be embodied (i.e., the details shall be completely within the scope understandable by those skilled in the art). While specific details (e.g., circuits) have been described to illustrate exemplary embodiments of the present disclosure, it shall be apparent to those skilled in the art that, the present disclosure may be embodied without these specific details or with variations of the specific details. Therefore, the description shall be considered to be illustrative rather than in a limiting sense.

Although the present disclosure has been described with reference to embodiments thereof, many replacements, modifications and variants of these embodiments will be apparent to those of ordinary skill in the art upon reviewing the above description. For example, other memory architectures (e.g., dynamic RAM (DRAM) may also utilize the discussed embodiments.

Embodiments of the present disclosure are intended to cover all such replacements, modifications and variations falling within the broad scope of the attached claims. Accordingly, any omissions, modifications, equivalent replacements, and alterations within the spirits and principles of the present disclosure shall be included in the scope of the present disclosure.

What is claimed is:

1. A method for automatically pushing a video based on user behavior analysis, comprising:
at an electronic device:
obtaining a watching record of a video file;
determining whether there is a video file of which a watching duration is greater than a preset duration threshold according to the watching record;
extracting a video information identification (ID) of the video file if there is a video file of which the watching duration is greater than the preset duration threshold;
storing the video information ID into a video update table if there is a video file having the same video information ID; and
pushing the update information, if it is monitored that there is update information of the video file corresponding to the video information ID in the video update table.

2. The method according to claim 1, wherein the determining whether there is a video file of which a watching duration is greater than a preset duration threshold comprises:
obtaining a watching time period of the video file;
determining whether there is an advertisement playing time within the watching time period; and
determining whether the watching duration minus the advertisement playing time is greater than the preset duration threshold if there is the advertisement playing time within the watching time period.

3. The method according to claim 2, wherein the storing the video information ID into a video update table if there is a video file having the same video information ID comprises:
calculating the number of video files having the same video information ID;
sorting the video files by the size of the numbers of video files having the same video information ID; and
storing the number of video information IDs into the video update table.

4. The method according to claim 1, wherein the storing the video information ID into a video update table if there is a video file having the same video information ID comprises:
calculating the number of video files having the same video information ID;
sorting the video files by the size of the numbers of video files having the same video information ID; and
storing the number of video information IDs into the video update table.

5. An electronic device, comprising:
at least one processor; and
a memory communicably connected with the at least one processor for storing instructions executable by the at least one processor, wherein execution of the instructions by the at least one processor causes the at least one processor to:
obtain a watching record of a video file;
determine whether there is a video file of which a watching duration is greater than a preset duration threshold according to the watching record;
extract a video information identification (ID) of the video file if there is a video file of which the watching duration is greater than the preset duration threshold;
store the video information ID into a video update table if there is a video file having the same video information ID; and
push the update information if it is monitored that there is update information of the video file corresponding to the video information ID in the video update table.

6. The electronic device according to claim 5, wherein the determining whether there is a video file of which a watching duration is greater than a preset duration threshold comprises:
obtaining a watching time period of the video file;
determining whether there is an advertisement playing time within the watching time period; and
determining whether the watching duration minus the advertisement playing time is greater than the preset duration threshold if there is the advertisement playing time within the watching time period.

7. The electronic device according to claim 5, wherein the storing the video information ID into a video update table if there is a video file having the same video information ID comprises:
calculating the number of video files having the same video information ID;
sorting video files in the order of the numbers of video files having the same video information; and
storing the number of video information IDs into the video update table.

8. A non-transitory computer-readable storage medium storing executable instructions, wherein when executed by an electronic device, causes the electronic device to:
obtain a watching record of a video file;
determine whether there is a video file of which a watching duration is greater than a preset duration threshold according to the watching record;
extract a video information identification (ID) of the video file if there is a video file of which the watching duration is greater than the preset duration threshold;
store the video information ID into a video update table if there is a video file having the same video information ID; and
push the update information if it is monitored that there is update information of the video file corresponding to the video information ID in the video update table.

9. The non-transitory computer-readable storage medium according to claim 8, wherein the determining whether there is a video file of which a watching duration is greater than a preset duration threshold comprises:
obtaining a watching time period of the video file;
determining whether there is an advertisement playing time within the watching time period; and
determining whether the watching duration minus the advertisement playing time is greater than the preset duration threshold if there is the advertisement playing time within the watching time period.

10. The non-transitory computer-readable storage medium according to claim 8, wherein the storing the video information ID into a video update table if there is a video file having the same video information ID comprises:
calculate the number of video files having the same video information ID;
sort video files in the order of the numbers of video files having the same video information; and
store the number of video information IDs into the video update table.
